(19) United States
(12) Patent Application Publication
(10) Pub. No.: US 2018/0206484 A1
(43) Pub. Date: Jul. 26, 2018

(54) AGROFORMULATION COMPRISING COPOLYMERS CONTAINING HYDROXYBUTYL VINYL ETHER AS ASSOCIATIVE THICKENER

(71) Applicant: BASF SE, Ludwigshafen am Rhein (DE)

(72) Inventors: Christian Bittner, Bensheim (DE); Tobias Zimmermann, Traunstein (DE); Diana Eissmann, Tacherting (DE); Meik Ranft, Schwetzingen (DE); Erik Gubbels, Trostberg (DE); Diana Westfalia Moran Puente, Nussloch (DE)

(21) Appl. No.: 15/745,735

(22) PCT Filed: Jul. 13, 2016
(86) PCT No.: PCT/EP2016/066589

§ 371 Date: Jan. 18, 2018

(30) Foreign Application Priority Data
Jul. 22, 2015 (EP) 15177851.1

(51) Int. Cl. A01N 25/10; A01N 57/20; A01N 37/40; A01N 43/653; A01N 25/30

(52) U.S. Cl. CPC A01N 25/10; A01N 57/20; A01N 25/30; A01N 43/653; A01N 37/40

(57) ABSTRACT

Provided herein is an agrochemical composition comprising a pesticide and at least one water-soluble copolymer (P) including at least one monomer (A), selected from the group consisting of (meth)acrylamide, N-methyl(meth)acrylamide, N,N′-dimethyl(meth)acrylamide or N-methylol(meth)acrylamide; at least one macromonomer (B), at least including a macromonomer (B1)

H₂C═C(R¹)—R²—O—(R³O)ₐ—(R⁴O)_{b}—[(R⁴O)_{c}(R⁵O)_{d}]—H; and (B1)

at least one anionic monoethylenically unsaturated monomer (C), including at least one acidic group selected from —COOH, —SO₃H, PO₃H₂, and salts thereof.

Further provided herein is the production of a spray mixture, including the contacting of a pesticide, the water-soluble copolymer (P), and water; and also a method for controlling phytopathogenic fungi, unwanted plant growth, unwanted insect infestation or mite infestation, and/or for regulating plant growth. The agrochemical composition acts on a pest, its environment, a crop plant to be protected from the pest, on the soil, the unwanted plant, the crop plant, and/or its environment.

The present invention relates to an agrochemical composition comprising a pesticide and at least one water-soluble copolymer (P), where the copolymer (P) at least comprises
(A) 30 to 99.99 wt % of at least one monomer (A), selected from the group consisting of (meth)acrylamide, N-methyl(meth)acrylamide, N,N′-dimethyl(meth)acrylamide or N-methylol(meth)acrylamide;
(B) 0.01 to 15 wt % of at least one macromonomer (B), at least comprising a macromonomer (B1)

H₂C═C(R¹)—R²—O—(R³O)ₐ—(R⁴O)_{b}—[(R⁴O)_{c}(R⁵O)_{d}]—H; and (B1)
(C) 0.1 to 69.99 wt % of at least one anionic monoethylenically unsaturated monomer

(C), comprising at least one acidic group selected from —COOH, —SO₃H, PO₃H₂, and salts thereof;

where the radicals and indices have the following definitions:
R¹: H or methyl,
R²: a single bond or a divalent linking group —OR³⁵—, where R³⁵ is an alkylene group having 1 to 6 carbon atoms,
R³: independently at each occurrence ethylene groups —CH₂CH₂—, 1,2-propylene groups —CH₂—CH(CH₃)—, or alkylene groups R⁴, with the proviso that at least 90 mol % of the radicals R³ are ethylene groups,
R⁴: independently at each occurrence alkylene groups —CR⁶(R⁷)—CR⁵(R⁹)—, where the radicals R⁶, R⁷, R⁵ and R⁹ independently of one another are H or a linear or branched alkyl radical having 1 to 8 carbon atoms, with the proviso that not all the radicals are H and the sum of the carbon atoms in the radicals R⁶, R⁷,
R⁵ and R⁹ is 2 to 8,
R⁵: an ethylene group —CH₂CH₂—,
a is a number from 10 to 150,
b is a number from 5 to 30,
c is a number from 0 to 2,
d is a number from 0 to 20, and
   where the quantity figures of the monomers are based in each case on the total amount of all the monomers in the copolymer (P).

A further aspect is formed by a method for producing a spray mixture, comprising the contacting of a pesticide, the water-soluble copolymer (P) and water; and also by a method for controlling phytopathogenic fungi and/or unwanted plant growth and/or unwanted insect infestation or mite infestation and/or for regulating plant growth, where the agrochemical composition is caused to act on the pest, its environment, the crop plant to be protected from the pest, on the soil and/or the unwanted plant and/or the crop plant and/or its environment.

There continues to be a need within the agrochemical industry to provide pesticide formulations having improved properties. Wind drift in particular poses a major problem in terms of pesticide consumption, safe handling, toxicity, and development of resistance. The wind drift is influenced by the formation of droplets during the operation of spraying through nozzles. Droplet formation is a complex process, dependent on numerous factors such as, for instance, the density and the surface tension of the agrochemical composition.

The object of the present invention was therefore that of producing agrochemical formulations having improved spraying properties, including reduced wind drift.

It has now surprisingly emerged that the addition of water-soluble copolymers (P), as defined above, in agrochemical formulations reduces the wind drift and therefore solves the problems stated. The copolymers (P) can be produced on an industrial scale, are nontoxic, and exhibit low sensitivity toward electrolytes, such as ionic pesticides, for example.

The copolymer (P) is customarily a hydrophobically associating copolymer. The term “hydrophobically associating copolymers” is known in principle to the skilled person. It relates to water-soluble copolymers which as well as hydrophilic moieties have hydrophobic groups. In aqueous solution, the hydrophobic groups are able to associate with themselves or with other substances having hydrophobic groups, by means of intermolecular forces. This produces a polymeric network linked by intermolecular forces, which strengthens the viscosity-increasing effect of the copolymers.

The water solubility of the copolymer (P) at 25° C. and pH 7 may be up to 100 g/l, preferably up to 100 g/l, and more preferably up to 25 g/l.

In accordance with the invention, the water-soluble, hydrophobically associating copolymer comprises 30 to 99.99 wt % of at least one monomer (A), preferably acrylamide, and also 0.01 to 15 wt % of at least one amphiphilic macromonomer (B) comprising—in addition to the monoethylenically unsaturated group—a hydrophilic and a hydrophobic group. Furthermore, of course, there may be other ethylenically unsaturated monomers present, especially monoethylenically unsaturated monomers.

The properties of the copolymers (P) may be modified and adapted to the desired end use by means of further monomers. With regard to further, ethylenically unsaturated monomers, the skilled person makes a suitable selection in line with the properties desired for the polymer.

Further ethylenically unsaturated monomers are hydrophilic, anionic, monoethylenically unsaturated monomers (C) comprising at least one acidic group and/or salts thereof.

### Monomers (A)

In accordance with the invention, the copolymer (P) comprises at least one monomer (A) selected from the group of (meth)acrylamide, N-methyl(meth)acrylamide, N,N′-dimethyl(meth)-acrylamide or N-methylol(meth)acrylamide. The monomer (A) is preferably (meth)acrylamide, more particularly acrylamide. Where mixtures of different monomers (A) are used, at least 50 mol % of the monomers (A) ought to comprise (meth)acrylamide, preferably acrylamide.

In accordance with the invention, the amount of the monomers (A) is 30 to 99.99 wt %, based on the sum of all the monomers in the copolymer (P), preferably 30 to 99.9 wt %, more particularly 35 wt % to 99.5 wt %, and, for example, 45 to 99.5 wt %.

### Macromonomers (B)

The copolymer (P) comprises at least one amphiphilic, monoethylenically unsaturated macromonomer (B).

In accordance with the invention, the macromonomer (B) comprises at least one macromonomer (B1) of the general formula

H₂C═C(R¹)—R²—O—(R³O)ₐ—(R⁴O)_{b}—[—(R⁴O)_{c}(R⁵O)_{d}]—H. (B1)

The macromonomer (B) preferably further comprises at least one macromonomer (B2) of the general formula

H₂C═C(R¹)—R²—O—(R³O)ₐ—(R⁴O)_{b}—H. (B2)

The radicals and indices in the formulae (B1) and (B2) here, independently of one another, have the definition outlined hereinafter.

R¹ is H or a methyl group, preferably H.

R² is a single bond or, preferably, a divalent linking group —OR³⁵—, where R³⁵ is a linear or branched alkylene group having 1 to 6 carbon atoms. Preferably R² is a linear 1,ω-alkylene group —(CH₂)ₖ—, where k is 1 to 6, preferably 3 to 6, and more preferably 4.

The radicals R³ independently of one another are ethylene groups —CH₂CH₂—, 1,2-propylene groups —CH₂CH(CH₃)— or 1,2-alkylene groups R⁴, with the proviso that at least 90 mol % of the radicals R³ are ethylene groups. Preferably at least 95 mol % of the radicals R³ are ethylene groups, and very preferably the radicals R³ exclusively are ethylene groups. —(R³O)ₐ— is therefore a block which consists essentially of ethyleneoxy groups and may additionally include, optionally, small amounts of higher alkyleneoxy groups.

The index a is a number from 10 to 150, preferably 10 to 35, more preferably 15 to 30, especially preferably 20 to 28, and, for example, 23 to 26.

The radicals R⁴ independently of one another are alkylene groups —CR⁶R⁷—CR⁸R⁹—, where the radicals R⁶, R⁷, R⁸ and R⁹ independently of one another are H or a linear or branched alkyl radical having 1 to 8 carbon atoms, preferably 1 to 3 carbon atoms, with the proviso that not all radicals are H and that the sum of the carbon atoms in the radicals R⁶, R⁷, R⁸ and R⁹ is 2 to 8, preferably 2 or 3. The radicals may, for example, be methyl, ethyl or propyl radicals. —(R⁴O)_{b}— is therefore a block of alkyleneoxy groups which comprise at least 4 carbon atoms.

The index b is a number from 5 to 30, more particularly 5 to 25, preferably 7 to 25, very preferably 8 to 20, and, for example 8 to 18 or, for example, 12 to 20.
R⁵ is an ethylene group —CH₂CH₂—.

In formula (B1) above, —[(R⁴O)_{c}(R⁵O)_{d}]— is an alkylene oxide block, comprising ethyleneoxy units —R⁵O— and also, optionally, alkyleneoxy units —R⁴O— as defined above, where the unit —R⁵O— and —R⁴O— as a general rule are arranged randomly, but may also have a blockwise or alternating arrangement.

The index c is a number from 0 to 2, more particularly 0 to 1.5, and, for example, 0.1 to 1. The index d is a number from 0 to 20, preferably 1 to 20, more preferably 1 to 15, especially from 1.5 to 10, and, in one example, 2 to 5.

In formula (B1), the groups —(R³O)ₐ—, —(R⁴O)_{b}— and —[(R⁴O)_{c}(R⁵O)_{d}]— are arranged in the order shown in formula (B1), and in formula (B2) the groups —(R³O)ₐ— and —(R⁴O)_{b}— are arranged in the order shown in the formula (B2).

For the person skilled in the field of polyalkoxylates it is clear that alkoxylation produces a distribution of chain lengths, and that the indices a, b, c and d are average values taken across all the molecules. The indices a, b, c and d, accordingly, are rational numbers rather than natural numbers.

In one embodiment of the invention, in the radicals R⁴, in each case 2 or 3, preferably 3, of the radicals R⁶, R⁷, R⁸ and R⁹ are H. In one embodiment, in the radicals R⁴, in each case 2 or 3, preferably 3, of the radicals R⁶, R⁷, R⁸ and R⁹ are H, with the sum of the carbon atoms in the radicals R⁶, R⁷, R⁸ and R⁹ being 2 or 3 in each case.

In one embodiment of the invention, the sum of carbon atoms in the radicals R⁶, R⁷, R⁸ and R⁹ is in each case 2, and at least 70 mol %, preferably at least 80 mol % and more preferably at least 95 mol %, of the units —CR⁶R⁷CR⁸R⁹— have H for R⁶, R⁷ and R⁸, and ethyl for R⁹. In this embodiment, therefore, —R⁴O— comprises butyleneoxy groups, preferably butyleneoxy groups which derive essentially from butene 1,2-oxide.

In one embodiment of the invention, the sum of carbon atoms in the radicals R⁶, R⁷, R⁸ and R⁹ is in each case 3, and at least 70 mol %, preferably at least 80 mol % and more preferably at least 95 mol %, of the units —CR⁶R⁷CR⁸R⁹— have H for R⁶, R⁷ and R⁸, and n-propyl for R⁹. In this embodiment, therefore, —R⁴O— comprises pentyleneoxy groups, more preferably pentyleneoxy groups which derive essentially from pentene 1,2-oxide.

Where there is to be a mixture of (B1) and (B2), the molar fraction x of the macromonomers (B1), based on the sum of (B1) and (B2), is 0.1 to 0.99, more particularly 0.3 to 0.99, preferably 0.3 to 0.95, more preferably 0.45 to 0.9, very preferably 0.5 to 0.9, and, for example, 0.5 to 0.8.

Preference is given to macromonomers (B) wherein the radical R¹ is H, the radical R² is OR³⁵, and the radical R³ is CH₂CH₂, more preferably wherein the radical R¹ is H, the radical R² is OR³⁵, and the radical R³ is CH₂CH₂, and the radical R³⁵ is a group —CH₂CH₂—. Preference is further given to macromonomers (B) wherein the indices a are a number from 10 to 35, the index b is a number from 5 to 30, and the index d is a number from 2 to 5.

Particular preference is additionally given to macromonomers (B) wherein the indices a are a number from 10 to 35, the index b is a number from 7 to 25, and the index d is a number from 2 to 5.

Preference is additionally given to macromonomers (B) wherein the indices a are a number from 20 to 28, the index b is a number from 8 to 20, and the index d is a number from 2 to 5.

Particular preference is additionally given to macromonomers (B) wherein indices a are a number from 23 to 26, the index b is a number from 12 to 20, and the index d is a number from 2 to 5.

In one preferred embodiment of the invention, the sum b+c of the radicals R⁴O present is selected with the proviso that the sum of all the carbon atoms in all the radicals R⁶, R⁷, R⁸ and R⁹ present is together 25 to 50, preferably 28 to 46. In this embodiment, in other words, the greater the number of carbon atoms comprised in the alkyleneoxy units R⁴O, the smaller the sum of the radicals R⁴O.

In a further embodiment of the invention, 2 or 3, preferably 3, of the radicals R⁶, R⁷, R⁸ and R⁹ in R⁴ are H, and the sum of the carbon atoms in the radicals R⁶, R⁷, R⁸ and R⁹ is 2 or 3, with the sum b+c of the radicals R⁴O present being selected with the proviso that the sum of all the carbon atoms in all of the radicals R⁶, R⁷, R⁸ and R⁹ present is together 25 to 50, preferably 28 to 46.

In one preferred embodiment of the invention, the macromonomers (B) are macromonomers (B1) or a mixture of (B1) and (B2) in which R³ is ethylene groups and the sum of the carbon atoms in the radicals R⁶, R⁷, R⁸ and R⁹ is 2, where R⁶, R⁷ and R⁹ are H and R⁹ is ethyl for at least 70 mol %, preferably at least 80 mol % and more preferably at least 95 mol % of the units —CR⁶R⁷CR⁸R⁹—. In other words, the radicals R⁴ are butylene groups. Moreover, a is a number from 20 to 28, preferably 23 to 26, b is a number from 10 to 25, preferably 14 to 23, more preferably 14 to 20, very preferably 14 to 18, c is 0 to 1.5, preferably 0.5 to 1.5, d is a number from 1.5 to 10, preferably 1.5 to 5. The molar fraction x of the macromonomers (B1) in this embodiment is, in particular, 0.3 to 0.95, preferably 0.45 to 0.9, based on the sum of the monomers (B1) and (B2) together.

In a further embodiment of the invention, the macromonomers (B) are macromonomers (B1) or a mixture of (B1) and (B2) in which R³ is ethylene groups, the sum of the carbon atoms in the radicals R⁶, R⁷, R⁸ and R⁹ is 3, and R⁶, R⁷ and R⁸ are H and R⁹ is n-propyl for at least 70 mol %, preferably at least 80 mol % and more preferably at least 95 mol % of the units —CR⁶R⁷CR⁸R⁹—. In other words, the radicals R⁴ are pentylene groups. Moreover, a is a number from 20 to 28, preferably 23 to 26, b is a number from 5 to 16, preferably 8 to 12, c is 0 to 1.5, preferably 0.5 to 1.5, d is a number from 1.5 to 10, preferably 1.5 to 5. The molar fraction x of the macromonomers (B1) in this embodiment is, in particular, 0.3 to 0.95, preferably 0.45 to 0.9, based on the sum of the monomers (B1) and (B2) together.

Besides the macromonomers (B1) or a mixture of (B1) and (B2), it is of course also possible for there to be further, different, amphiphilic macromonomers comprising hydrophobic and hydrophilic groups. Different macromonomers of this kind are known in principle to the skilled person. They may in particular be derivatives of acrylamide, acrylic acid, maleic acid, vinyl units or allyl units. Examples include, in particular, macromonomers based on (meth)acrylic acid of the general formula H₂C═C(R¹⁸)—COO—(CH₂CH₂O)ₗ—R¹⁹, where R¹⁸ is H or methyl, I is a number from 5 to 50, and R¹⁹ is a hydrocarbyl group having 8 to 36 carbon atoms. Further examples include cationic monomers of the general formula H₂C═C(R¹⁸)—CO—NH—R³⁶—N⁺(CH₃)₂R³⁷ X⁻, where R³⁶ is an alkylene group having 2 to 6 carbon atoms, preferably a 1,ω-alkylene group having 2 to 6 carbon atoms, R³⁷ is a hydrocarbyl group having 8 to 30 carbon atoms, and X⁻ is an anion.

If there are further macromonomers (B) besides the macromonomers (B1) and (B2), the fraction of (B1) and (B2) ought to be at least 50 wt %, based on the sum of all the macromonomers used, preferably at least 80 wt %. With particular preference there are exclusively macromonomers (B1) and (B2).

In one example, the copolymer (P) comprises a macromonomer (B1) and/or (B2) where R¹ is H, R² is —(CH₂)₄—, R³ is ethylene, and the indices a are numbers from 10 to 150, b from 5 to 30, d from 1 to 20, and c is 0.

In another example, the copolymer (P) comprises a macromonomer (B1) or a mixture of (B1) and (B2) where R¹ is H, R² is —(CH₂)₄—, R³ is ethylene, and the indices a are numbers from 10 to 35, b from 8 to 20, d from 1 to 15, and c is 0.

In another example, the copolymer (P) comprises a macromonomer (B1) or a mixture of (B1) and (B2) where R¹ is H, R² is —(CH₂)₄—, R³ is ethylene, the sum of the carbons in the radicals R⁶, R⁷, R⁸ and R⁹ is 2 or 3, and the indices a are numbers from 10 to 35, b from 8 to 20, d from 1 to 15, and c is 0.

In another example, the copolymer (P) comprises a macromonomer (B1) or a mixture of (B1) and (B2) where R¹ is H, R² is —(CH₂)₄—, R³ is ethylene, the sum of the carbons in the radicals R⁶, R⁷, R⁸ and R⁹ is 2 or 3, and the indices a are numbers from 10 to 35, b from 8 to 20, d from 1 to 15, and c is 0.

In another example, the copolymer (P) comprises a macromonomer (B1) or a mixture of (B1) and (B2) where R¹ is H, R² is —(CH₂)₄—, R³ is ethylene, the sum of the carbons in the radicals R⁶, R⁷, R⁸ and R⁹ is 2 or 3, and the indices a are numbers from 23 to 26, b from 12 to 20, d from 2 to 5, and c is 0.

In another example, the copolymer (P) comprises a macromonomer (B1) or a mixture of (B1) and (B2) where R¹ is H, R² is —(CH₂)₄—, R³ is ethylene, the sum of the carbons in the radicals R⁶, R⁷, R⁸ and R⁹ is 2 or 3, and the indices a are numbers from 10 to 150, b from 5 to 25, d from 0 to 20, and c is 0.

In accordance with the invention, the amount of the macromonomers (B), preferably the total amount of (B1) and (B2), is 0.01 to 15 wt %, based on the sum of all the monomers in the copolymer (P), preferably 0.1 to 10 wt %, more preferably 0.5 to 8 wt %, very preferably 0.8 to 5 wt %, and, for example, 1 to 2.5 wt %.

Macromonomers (B1) and (B2) may be prepared by the protocols from PCT/EP2014/076772.

### Monomers (C)

Besides the monomers (A) and (B), the copolymer (P) comprises at least one anionic, monoethylenically unsaturated monomer (C), comprising at least one acidic group selected from —COOH, —SO₃H, PO₃H₂, and salts thereof.

Examples of monomers comprising COOH groups include acrylic acid, methacrylic acid, crotonic acid, itaconic acid, maleic acid or fumaric acid. Acrylic acid is preferred.

Examples of monomers comprising sulfonic acid groups include vinylsulfonic acid, allylsulfonic acid, 2-acrylamido-2-methylpropanesulfonic acid, 2-methacrylamido-2-methylpropanesulfonic acid, 2-acrylamidobutanesulfonic acid, 3-acrylamido-3-methylbutanesulfonic acid or 2-acrylamido-2,4,4-trimethylpentanesulfonic acid. Preferred are vinylsulfonic acid, allylsulfonic acid or 2-acrylamido-2-methylpropanesulfonic acid, and particularly preferred is or 2-acrylamido-2-methylpropanesulfonic acid.

Examples of monomers comprising phosphonic acid groups include vinylphosphonic acid, allylphosphonic acid, N-(meth)acrylamidoalkylphosphonic acids or (meth)acryloyloxyalkyl-phosphonic acids, preference being given to vinylphosphonic acid.

The acidic group preferably comprises at least one acidic group selected from COOH groups and/or —SO₃H groups.

The acidic groups may of course be wholly or partly neutralized, meaning that they may take the form of salts. Suitable counterions for the acidic group include, in particular, alkali metal ions such as Li⁺, Na⁺ or K⁺, and also ammonium ions NH₄⁺ and ammonium ions with organic radicals.

Examples of ammonium ions with organic radicals include ammonium ions of the general formula [NHR²⁰R²¹R²²]⁺ (VI), in which the radicals R²⁰, R²¹ and R²² independently of one another are H or aliphatic and/or aromatic hydrocarbyl radicals having 1 to 12, preferably 1 to 6, carbon atoms, it being possible for the hydrocarbyl radicals to be substituted by OH groups and/or for nonadjacent carbon atoms to be substituted by O or N, with the proviso that at least one of the radicals R²⁰, R²¹ and R²² is not H. Moreover, they may be ammonium ions of the general formula [R²⁰R²¹HN—R²³—NHR²⁰R²¹]²⁺ (VII), where R²⁰ and R²¹ have the definition outlined above and R²³ is an alkylene radical having 1 to 6 carbon atoms, preferably a 1,ω-alkylene radical having 2 to 6 carbon atoms. Examples of ammonium ions with organic radicals include [NH(CH₃)₃]⁺, [NH₂(CH₃)₂]⁺, [NH₃(CH₃)]⁺, [NH(C₂H₅)₃]⁺, [NH₂(C₂H₅)₂], [NH₃(C₂H₅)]⁺, [NH₃(CH₂CH₂OH)]⁺, [H₃N—CH₂CH₂—NH₃]²⁺ or [H(H₃C)₂N—CH₂CH₂CH₂NH₃]²⁺.

Preferred counterions are Li⁺, Na⁺ or K⁺, or NH₄⁺, particularly Na⁺ or NH₄⁺, especially NH₄⁺. Mixtures of counterions are likewise encompassed by the recitation above.

Salts can be obtained by carrying out whole or partial neutralization of monomers (C) in the acid form with the corresponding bases prior to the polymerization. Of course, monomers (C) can also be used in the acid form for the polymerization, and acid groups in the resulting copolymer (P) can be wholly or partly neutralized after the polymerization.

The amount of the monomers (C) is 0.1 to 69.99 wt %, more particularly 5 to 64.9 wt %, based on the sum of all the monomers in the copolymer (P).

One preferred monomer (C) conforms to formula (I)

CH₂═CH₂—C(O)XR⁵SO₃H (I),
where
X is N or O; and
R⁵ is CH₂, CH₂CH₂, C(CH₃)₂, CH(CH₃), CH(CH₃)CH₂, CH₂CH(CH₃), C(CH₃)₂CH₂, CH₂C(CH₃)₂.

Preferred radicals R⁵ are CH₂CH₂, CH(CH₃)CH₂, CH₂CH(CH₃), C(CH₃)₂CH₂, or CH₂C(CH₃)₂, very preferably C(CH₃)₂CH₂, or CH₂C(CH₃)₂, especially C(CH₃)₂CH₂.

In one embodiment of the formula (I), the radical X is N, and R¹⁰ is CH₂CH₂, CH(CH₃)CH₂, CH₂CH(CH₃), C(CH₃)₂CH₂, or CH₂C(CH₃)₂, more preferably C(CH₃)₂CH₂, or CH₂C(CH₃)₂, especially C(CH₃)₂CH₂.

In another embodiment of the formula (I), the radical X is O, and R¹⁰ is CH₂CH₂, CH(CH₃)CH₂, CH₂CH(CH₃), C(CH₃)₂CH₂, or CH₂C(CH₃)₂, more preferably C(CH₃)₂CH₂, or CH₂C(CH₃)₂, especially C(CH₃)₂CH₂.

In one preferred embodiment, the copolymer (P) comprises at least two different monomers (C), preferably at least one monomer (C) containing a —COOH group and at least one monomer containing an —SO₃H group, more preferably (meth)acrylic acid and a monomer of the formula (I).

In another embodiment, the copolymer (P) comprises at least one monomer (C) having a —COOH group, preferably acrylic acid and methacrylic acid, more preferably acrylic acid.

### Monomers (D)

Furthermore, the copolymers (P) may also comprise further monoethylenically unsaturated monomers (D), which are different from the monomers (A), (B), and (C).

With particular preference, monomers (D) employed optionally are miscible with water in any desired proportion. As a general rule, the solubility of the monomers (D) in water at room temperature ought to be at least 25 g/l, preferably at least 50 g/l, and more preferably at least 100 g/l.

Examples of monomers (D) include monomers comprising hydroxyl and/or ether groups, such as, for example, hydroxyethyl (meth)acrylate, hydroxypropyl (meth)acrylate, allyl alcohol, hydroxyvinyl ethyl ether, hydroxyvinyl propyl ether, hydroxyvinyl butyl ether, or compounds of the formula H₂C═C(R¹⁵)—COO—(-CH₂—CH(R¹⁶)—O—)_{b}—R¹⁷ (X) and/or H₂C═C(R¹⁵)—O—(-CH₂—CH(R¹⁶)—O—)_{b}-R¹⁷ (XI), where R¹⁵ is H or methyl and b is a number from 2 to 200, preferably 2 to 100. The radicals R¹⁶ independently of one another are H, methyl or ethyl, preferably H or methyl, with the proviso that at least 50 mol % of the radicals R¹³ are H. With preference at least 75 mol % of the radicals R¹⁶ are H, more preferably at least 90 mol %, and very preferably they are exclusively H. The radical R¹⁷ is H, methyl or ethyl, preferably H or methyl. Further examples of monomers (D) include N-vinyl derivatives such as, for example, N-vinylformamide, N-vinyl-acetamide, N-vinylpyrrolidone or N-vinylcaprolactam, and also vinyl esters, such as vinyl formate or vinyl acetate, for example. N-vinyl derivatives may be hydrolyzed after polymerization to form vinylamine units, and vinyl esters may be hydrolyzed to form vinyl alcohol units. Preferred monomers (D) are N-vinylpyrrolidone or N-vinylcaprolactam and also vinyl esters, such as vinyl formate or vinyl acetate, for example, especially N-vinylpyrrolidone or N-vinylcaprolactam, more particularly N-vinylpyrrolidone. In one embodiment the copolymer (P) comprises a monomer (D), preferably N-vinylpyrrolidone. In another embodiment the copolymer (P) comprises no monomer (D).

Where they are present at all, the amount of the monomers (D) ought not to exceed 15 wt %, preferably 10 wt %, more preferably 5 wt %, based on the sum of all the monomers, and with very particular preference there are no monomers (D) present.

In another embodiment, copolymers (P) comprise 0.1 to 30 wt % of monomers (D), preferably 1 to 20 wt %, more preferably 1 to 10 wt %.

### Monomers (E)

The copolymers (P) may, furthermore, also comprise other polyethylenically unsaturated monomers (E), which are different from the monomers (A), (B), (C) and (D).

Examples of monomers (E) are N,N-methylenebisacrylamide, N,N-methylenebis-methacrylamide, triallylamine, triallylammonium salts, tetraallylammonium salts, ethyleneglycol dimethacrylate, diethylene glycol dimethacrylate, polyethylene glycol diacrylate, triethylene glycol dimethylacrylate, polyethylene glycol dimethacrylate, N-vinylacrylamide, N-methylallylacrylamides, and also the polyesters of polyols with acrylic acid and/or methacrylic acid, examples being trimethylolpropane triacrylate and trimethacrylate, pentaerythritol triallyl ether, pentaerythritol tetraallyl ether, pentaerythritol triacrylate and pentaerythritol tetraacrylate, and also their technical mixtures.

Preference is given to trimethylolpropane triacrylate and trimethacrylate, pentaerythritol triallyl ether, pentaerythritol tetraallyl ether, pentaerythritol triacrylate and pentaerythritol tetraacrylate, and also their technical mixtures, and tetraallylammonium salts, such as tatraallylammonium chloride. In one embodiment tetraallylammonium salts, preferably tetraallylammonium chloride, are preferred monomers (E).

The amount of the monomers (E) in the copolymers (P) is customarily 0.001 to 20 wt %, preferably 0.001 to 5 wt %, more preferably 0.001 to 1 wt %, especially 0.001 to 0.1 wt %. In one embodiment the copolymers (P) contain no monomers (E).

### Preparation of the Copolymers (P)

The copolymers of the invention can be prepared by methods known in principle to the skilled person, by radical polymerization of the monomers (A), (B), (C) and optionally (D) and/or (E) in aqueous solution, by means for example of solution polymerization, gel polymerization or inverse emulsion polymerization. The stated polymerization techniques are known in principle to the skilled person.

For the polymerization, aqueous solutions or of the monomers can be used together with suitable initiators for the radical polymerization, and polymerized. Polymerization may take place thermally and/or photochemically. For the polymerization it is of course also possible to use further additives and auxiliaries, examples being defoamers or complexing agents.

In one preferred embodiment of the invention, the copolymers used are prepared in the presence of at least one nonpolymerizable, surface-active compound (T). The nonpolymerizable, surface-active compound (T) is preferably at least one nonionic surfactant, although anionic and cationic surfactants are also suitable, provided they do not take part in the polymerization reaction. The surfactants in question may more particularly be surfactants, preferably nonionic surfactants, of the general formula R¹⁸—Y, in which R¹⁸ is a hydrocarbyl radical having 8 to 32, preferably 10 to 20 and more preferably 12 to 18 carbon atoms, and Y is a hydrophilic group, preferably a nonionic hydrophilic group, more particularly a polyalkoxy group.

The nonionic surfactant is preferably an ethoxylated long-chain aliphatic alcohol which may optionally contain aromatic moieties. Examples include the following: C₁₂C₁₄ fatty alcohol ethoxylates, C₁₆C₁₈ fatty alcohol ethoxylates, C₁₃ oxo-process alcohol ethoxylates, C₁₀ oxo-process alcohol ethoxylates, C₁₃C₁₅ oxo-process alcohol ethoxylates, C₁₀ Guerbet alcohol ethoxylates, and alkylphenol ethoxylates. Compounds having 5 to 20 ethyleneoxy units, preferably 8 to 18 ethyleneoxy units, have proven particularly appropriate. Optionally it is also possible for small amounts of higher alkyleneoxy units to be present as well, especially propyleneoxy and/or butyleneoxy units, although the amount of ethyleneoxy units ought in general to be at least 80 mol % relative to all alkyleneoxy units.

Suitable in particular are surfactants selected from the group of ethoxylated alkylphenols, ethoxylated, saturated iso-C₁₃ alcohols and/or ethoxylated C₁₀ Guerbet alcohols, there being in each case 5 to 20 ethyleneoxy units, preferably 8 to 18 ethyleneoxy units, in alkyleneoxy radicals.

The addition of nonpolymerizable, surface-active compounds (T) during the polymerization results in a significant improvement in performance properties of the copolymer (P) in the context of polymer flooding. More particularly, the thickening effect is increased and, in addition, the gel content of the copolymer is reduced. This effect can probably be explained as follows, without any intention that the invention be confined to this explanation. In the case of polymerization in the absence of a surfactant, the macromonomers (B) form micelles in the aqueous reaction medium. During the polymerization this leads to blockwise incorporation of the hydrophobically associating regions into the polymer. If an additional surface-active compound is then present in the course of preparation of the copolymers, mixed micelles are formed. These mixed micelles comprise polymerizable and nonpolymerizable components. As a result, the macromonomers (B) are then incorporated in shorter blocks. At the same time, the number of these shorter blocks per polymer chain is greater. Accordingly, the structure of the copolymers prepared in the presence of a surfactant differs from those in the absence of a surfactant.

The nonpolymerizable, surface-active compounds (T) can generally be used in an amount of 0.1 to 5 wt %, based on the amount of all the monomers used. The weight ratio of the nonpolymerizable, surface-active compounds (T) used to the monomers (B) is generally 4:1 to 1:4, preferably 2:1 to 1:2, more preferably 1.5:1 to 1:1.5, and, for example, about 1:1.

In one embodiment, the copolymers (P) can be obtained by solution polymerization. For the solution polymerization, first of all a solution is provided which comprises the monomers (A), (B), (C) and optionally (D) and/or (E), and also water or an aqueous solvent mixture. Suitable aqueous solvent mixtures comprise water and also water-miscible organic solvents, with the fraction of water being generally at least 50 wt %, preferably at least 60 wt % and more preferably at least 70 wt %. In one embodiment of the invention, water exclusively is used as solvent. Water-miscible organic solvents include, in particular, alcohols such as methanol, ethanol or propanol. The concentration of all the monomers together is usually 1 to 40 wt %, preferably 5 to 30 wt %, as for example 10 to 20 wt %, based on the aqueous monomer solution. Acidic monomers may be wholly or partly neutralized before the polymerization. This can be done, for example, using alkali metal hydroxides or else using ammonia or amines. The polymerization ought in particular to be carried out at a pH in the range from 5 to 7.5, preferably 5 to 7, and, for example, at a pH of 6. The aqueous monomer solution may further comprise various additives, examples being defoamers or complexing agents.

To implement the solution polymerization, it is possible first of all to introduce water or an aqueous solution of suitable additives, such as surfactants, defoamers or complexing agent. The pH is subsequently adjusted to a range from 4 to 7, preferably 5 to 7, more preferably 5.5 to 6.5, using suitable acids and bases.

Suitable acids are generally organic acids, for instance C₁-C₆ carboxylic acids such as CH₃COOH, HCOOH, or CH₃CH₂COOH, or mineral acids, for instance H₂SO₄, HCl, or HNO₃. Suitable bases are generally inorganic compounds, such as alkali metal or alkaline earth metal hydroxides, as for instance LiOH, NaOH, KOH or Ca(OH)₂; alkali metal or alkaline earth metal oxides, such as Li₂O, Na₂O, CaO or MgO; alkali metal or alkaline earth metal carbonates, such as Li₂CO₃, Na₂CO₃, K₂CO₃ or CaCO₃; alkali metal or alkaline earth metal bicarbonates, such as NaHCO₃; or organic bases, examples being tertiary amines, such as trimethylamine, triethylamine, triisopropylethylamine and N-methylpiperidine, pyridine, substituted pyridines, such as collidine, lutidine and 4-dimethylaminopyridine, and also bicyclic amines. Following addition of the monomers, the aqueous monomer solution is heated conventionally to a temperature of 50 to 85° C., preferably 55 to 80° C. For polymerizing, the monomer solution is generally inertized, i.e. freed from any oxygen present. This can be done, for example, by purging the monomer solution with an inert gas such as nitrogen, argon or carbon dioxide. This purging may be done during the mixing and cooling of the aqueous monomer solution itself, in a separate apparatus for inertizing, such as the apparatus described in WO 03/066190 A1, for example, or else in the reactor itself. Inertizing preferably takes place ahead of the reactor.

After cooling has taken place, at least one radical polymerization initiator soluble in the monomer solution is added. The initiators may preferably be water-soluble, though initiators which are no longer readily water-soluble are also soluble in the monomer solution. The initiators may be thermal initiators and also photoinitiators. Preference is given to using thermal initiators.

Examples of thermal initiators are azoisobutyronitrile, dibenzoyl peroxide, 2,2′-azobis(2-methylpropionamidine) dihydrochloride, or sodium peroxide sulfate, or mixtures thereof. Where thermal initiators are used, catalysts are frequently added, examples being organic amines, such as tetramethylethylenediamine, or tetraethylenepentamine, or mixtures thereof. In one embodiment the initiator is added only at the start of the polymerization. In another embodiment the initiator is added both at the start of the polymerization and at least one further time, preferably one time, during the polymerization reaction.

The copolymers (P) obtained by solution polymerization generally have a weight-average molecular weight M_{w} of 50 000 g/mol to 800 000 g/mol, preferably 100 000 g/mol to 600 000 g/mol and, in particular, 100 000 g/mol to 500 000 g/mol.

The copolymer (P) obtained by solution polymerization usually has a weight-average molecular weight M_{w} of at least 150 000 g/mol, preferably at least 200 000 g/mol, more preferably 300 000 g/mol.

In one preferred embodiment, the radical polymerization is performed by means of gel polymerization, preferably adiabatic gel polymerization in aqueous phase.

Given that the gel polymerization constitutes merely a special case of solution polymerization, the gel polymerization is encompassed by the solution polymerization. Following features characterize the gel polymerization in particular.

The concentration of all the monomers together is usually 10 to 60 wt %, preferably 20 to 50 wt %, as for example 25 to 45 wt %, based on the aqueous monomer solution. The polymerization generally produces a solid polymer gel.

The gel polymerization takes place as a general rule without stirring. It may be accomplished preferably batchwise, as for example in a tubular reactor as described by GB 1,054,028. Particularly advantageously for this purpose it is possible to use conical reactors, as described for example by U.S. Pat. No. 5,633,329 or U.S. Pat. No. 7,619,046 B2.

The polymer gel obtained is preferably comminuted and dried. Drying ought to take place preferably at temperatures below 100° C. To avoid the polymer sticking together, a suitable release agent can be used for this step. The hydrophobically associating copolymer is obtained in the form of granules or powder.

Given that the resulting polymer powder or granules are used generally as an aqueous solution in the context of application at the site of use, the polymer has to be dissolved in water in situ. In that case there may be instances of unwanted caking with the high molecular mass polymers described. To prevent this, an auxiliary which accelerates or enhances the dissolution of the dried polymer in water may be added during the actual synthesis to the polymers of the invention. This auxiliary may be, for example, urea.

The copolymers (P) obtained by gel polymerization generally have a weight-average molecular weight M_{w} of 1*10⁶ g/mol to 30*10⁶ g/mol, preferably 6*10⁶ g/mol to 25*10⁶ g/mol, and, for example, 8*10⁶ g/mol to 20*10⁶ g/mol.

The copolymer (P) obtained by gel polymerization usually has a weight-average molecular weight M_{w} of at least 8*10⁵ g/mol, preferably at least 1*10⁶ g/mol, more preferably 2*10⁶ g/mol.

### Preferred Copolymers (P)

In one preferred embodiment of the invention, the copolymers (P) are copolymers (P1).

The copolymers (P1) comprise (meth)acrylamide, preferably acrylamide, as monomer (A). As macromonomers (B), the copolymers (P1) comprise mixtures of the macromonomers (B1) and (B2), with the molar fraction of the macromonomers (B1) being in particular 0.3 to 0.95, preferably 0.45 to 0.9, more preferably 0.5 to 0.9, and, for example, 0.5 to 0.8 based on the sum of (B1) and (B2).

Furthermore, for the copolymer (P1), the radicals and indices for the macromonomers (B1) and (B2) have the following definitions:
R¹: H or methyl,
R²: a divalent linking group —OR³⁵—, where R³⁵ is a linear 1,ω-alkylene group having 1 to 6, preferably 3 to 6, and more preferably 4 carbon atoms,
R³: ethylene groups —CH₂CH₂—,
R⁴: independently at each occurrence alkylene groups —CR⁶(R⁷)—CR⁸(R⁹)—, where the sum of the carbon atoms of R⁶, R⁷, R⁸ and R⁹ is in each case 2, and where for at least 70 mol %, preferably at least 80 mol %, and more preferably at least 95 mol % of the units —CR⁶(R⁷)CR⁸(R⁹)—, R⁶, R⁷, and R⁸ are H and R⁹ is ethyl,
R⁵: an ethylene group —CH₂CH₂—,
a is a number from 20 to 28, preferably 23 to 26,
b is a number from 10 to 25, preferably 14 to 23, more preferably 14 to 20, very preferably 14 to 18,
c is a number from 0 to 2, preferably 0 to 1.5, and d is a number from 1.5 to 10, preferably 1.5 to 5.

Besides the monomers (A) and (B), the copolymers (P1) further comprise at least one monomer (C) which comprises —SO₃H groups and/or salts thereof. Examples of such monomers have already been identified. Preferred are vinylsulfonic acid, allylsulfonic acid or 2-acrylamido-2-methylpropanesulfonic acid, and with particular preference the monomer (C) comprises 2-acrylamido-2-methylpropanesulfonic acid.

In the copolymers (P1), the amount of the monomers (A) is generally 40 to 60 wt %, preferably 45 to 55 wt %, the amount of the monomers (B) is 0.1 to 5 wt %, preferably 0.5 to 3 wt %, and, for example, 0.8 to 2.5 wt %, and the amount of the monomers (C) is 40 to 60 wt %, preferably 45 to 55 wt %, based in each case on the sum of all the monomers of the copolymer (P1). The total amount of the monomers (A), (B) and (C) in the copolymer (P1) is preferably 100 wt %. In one embodiment, the amount of the monomers (A) is 40 to 60 wt %, preferably 45 to 55 wt %, the amount of the monomers (B) is 0.1 to 5 wt %, preferably 0.5 to 3 wt %, and, for example, 0.8 to 2.5 wt %, the amount of the monomers (C) is 40 to 60 wt %, preferably 45 to 55 wt %, and the amount of the monomers (D) is 1 to 10 wt %, based in each case on the sum of all the monomers of the copolymer (P1).

### Copolymer (P2)

In another preferred embodiment of the invention, the copolymer (P) is a copolymer (P2).

The copolymers (P2) comprise (meth)acrylamide, preferably acrylamide, as monomer (A). As macromonomers (B), the copolymers (P2) comprise the mixture, already described, of the macromonomers (B1) and (B2), where the molar fraction of the macromonomers (B1) is in particular 0.3 to 0.95, preferably 0.45 to 0.9, more preferably 0.5 to 0.9, and, for example, 0.5 to 0.8 based on the sum of (B1) and (B2).

Furthermore, for the copolymer (P2), the radicals and indices for the macromonomers (B1) and (B2) have the definitions already outlined for copolymer (P1), including the outlined preferred ranges.

Besides the monomers (A) and (B), the copolymers (P2) further comprise at least two monomers (C), namely at least one monomer (C1) comprising COOH groups and/or salts thereof, and at least one monomer (C2) comprising SO₃H groups and/or salts thereof.

Examples of monomers (C1) have already been identified and include acrylic acid, methacrylic acid, crotonic acid, itaconic acid, maleic acid or fumaric acid. (Meth)acrylic acid is preferred, acrylic acid being particularly preferred.

Examples of monomers (C2) have already been identified. Preferred are vinylsulfonic acid, allylsulfonic acid or 2-acrylamido-2-methylpropanesulfonic acid, and with particular preference the monomer (C2) comprises 2-acrylamido-2-methylpropanesulfonic acid.

In the copolymers (P2), the amount of the monomers (A) is generally 30 to 85 wt %, preferably 40 to 80 wt %, the amount of monomers (B) is 0.5 to 10 wt %, preferably 0.8 to 5 wt %, the amount of monomers (C1) is 5 to 40 wt %, preferably 5 to 30 wt %, and the amount of monomers (C2) is 5 to 40 wt %, preferably 5 to 30 wt %, based in each case on the sum of all the monomers of the copolymer (P). The total amount of the monomers (A), (B) and (C) in the copolymer (P2) is preferably 100 wt %.

For example, the preferred copolymer (P2) comprises 30 to 99.99 wt % of (meth)acrylamide, 0.01 to 15 wt % of macromonomer (B1), and 5 to 64.9 wt % of monomer (C) comprising at least one monomer of formula (I) and at least one monomer having a —COOH group, with the radicals of the macromonomer (B1) and of the formula (I) having one of the above definitions.

In another example, the preferred copolymer (P2) comprises 45 to 99.5 wt % of (meth)acrylamide, 0.8 to 5 wt % of macromonomer (B1), and 5 to 64.9 wt % of monomer (C) comprising at least one monomer of formula (I) and at least one monomer having a —COOH group, with the radicals of the macromonomer (B1) and of the formula (I) having one of the above definitions.

In another example, the preferred copolymer (P2) comprises 45 to 99.5 wt % of (meth)acrylamide, 0.8 to 5 wt % of macromonomer (B1), 5 to 64.9 wt % of monomer (C) comprising at least one monomer of formula (I) and at least one monomer having a —COOH group, and up to 10 wt % of monomer (D), with the radicals of the macromonomer (B1) and of the formula (I) having one of the above definitions.

In another example, the preferred copolymer (P2) comprises 45 to 99.5 wt % of (meth)acrylamide, 0.8 to 5 wt % of macromonomer (B1), 5 to 64.9 wt % of monomer (C) comprising at least one monomer of formula (I) and at least one monomer having a —COOH group, and up to 10 wt % of N-vinylpyrrolidone, where the radicals R¹ are H, R² are —(CH₂)₄—, R³ and R⁵ are —CH₂CH₂—, R⁴ are —CR⁶R⁷—CR⁸R⁹—, in which the radicals R⁶, R⁷, R⁸ and R⁹ independently of one another are H or a linear or branched alkyl radical of 1 to 3 carbon atoms, with the proviso that not all the radicals are H and that the sum of the carbon atoms in the radicals R⁶, R⁷, R⁸ and R⁹ is 3, and where the indices a are 20 to 28, b are 8 to 18, c are 0, and d are 2 to 5.

Surfactants:

The agrochemical composition typically comprises a surfactant, preferably a nonionic surfactant.

Suitable surfactants are surface-active compounds, such as anionic, cationic, nonionic and amphoteric surfactants, block polymers, polyelectrolytes, and mixtures thereof. Such surfactants may be used as emulsifier, dispersant, solubilizer, wetting agent, penetrant, protective colloid, or auxiliary. Examples of surfactants are found in McCutcheon's, volume 1: Emulsifiers & Detergents, McCutcheon's Directories, Glen Rock, USA, 2008 (international edition or North-American edition).

Suitable anionic surfactants are alkali metal, alkaline earth metal or ammonium salts of sulfonates, sulfates, phosphates, carboxylates, and mixtures thereof. Examples of sulfonates are alkylarylsulfonates, diphenylsulfonates, alpha-olefinsulfonates, lignosulfonates, sulfonates of fatty acids and oils, sulfonates of ethoxylated alkylphenols, sulfonates of alkoxylated arylphenols, sulfonates of condensed naphthalenes, sulfonates of dodecyl- and tridecylbenzenes, sulfonates of naphthalenes and alkylnaphthalenes, sulfosuccinates or sulfosuccinamates. Examples of sulfates are sulfates of fatty acids and oils, of ethoxylated alkylphenols, of alcohols, of ethoxylated alcohols or of fatty acid esters. Examples of phosphates are phosphate esters. Examples of carboxylates are alkyl carboxylates and also carboxylated alcohol or alkylphenol ethoxylates.

Suitable nonionic surfactants are alkoxylates, N-substituted fatty acid amides, amine oxides, esters, sugar-based surfactants, polymeric surfactants, and mixtures thereof. Examples of alkoxylates are compounds such as alcohols, alkylphenols, amines, amides, arylphenols, fatty acids or fatty acid esters that have been alkoxylated with 1 to 50 equivalents. For the alkoxylation it is possible to use ethylene oxide and/or propylene oxide, preferably ethylene oxide. Examples of N-substituted fatty acid amides are fatty acid glucamides or fatty acid alkanolamides. Examples of esters are fatty acid esters, glycerol esters or monoglycerides. Examples of sugar-based surfactants are sorbitans, ethoxylated sorbitans, sucrose esters and glucose esters, or alkylpolyglucosides. Examples of polymeric surfactants are homo- or copolymers of vinylpyrrolidone, vinyl alcohols or vinyl acetate.

Suitable cationic surfactants are quaternary surfactants, examples being quaternary ammonium compounds having one or two hydrophobic groups, or salts of long-chain primary amines. Suitable amphoteric surfactants are alkylbetaines and imidazolines. Suitable block polymers are block polymers of the A-B or A-B-A type comprising polyethylene oxide and polypropylene oxide blocks, or of the A-B—C type comprising alkanol, polyethylene oxide and polypropylene oxide. Suitable polyelectrolytes are polyacids or polybases. Examples of polyacids are alkali metal salts of polyacrylic acid, or polyacid comb polymers. Examples of polybases are polyvinylamines or polyethylenamines.

Suitable surfactants are compounds which themselves have a negligibly low pesticidal activity, or none at all, and which improve the biological effects of the compound I on the target. Examples are surfactants, mineral or vegetable oils, and other auxiliaries. Further examples are found in Knowles, Adjuvants and additives, Agrow Reports DS256, T&F Informa UK, 2006, chapter 5.

Preferred nonionic surfactants are polyethers, examples being alkoxylates, more preferably alkoxylates of fatty amines, aryl alcohols, alkylaryl alcohols, fatty alcohols, or polymerizable alkylene oxide, ethylene oxide for example. Nonionic surfactants are, in particular, alkoxylates of C₅-C₂₀ fatty alcohols, or alkoxylates comprising polyethylene oxide and polypropylene oxide.

Suitable alkoxylates of C₅-C₂₀ fatty alcohols are ethoxylates, propoxylates, butoxylates, and also mixed alkoxylates comprising ethylene oxide, propylene oxide and butylene oxide, of hexanol, heptanol, octanol, nonanol, decanol, undecanol, dodecanol, tridecanol, tetradecanol, pentadecanol, hexadecanol, heptadecanol, octadecanol, nonadecanol, eicosanol, and also their branched isomers and unsaturated derivatives, examples being 2-ethylhexanol, isotridecanol, linoeyl alcohol, palmitoleyl alcohol, oleyl alcohol, or elaidyl alcohol. Preferred alkoxylates of

C₆-C₂₀ fatty alcohols are decanol ethoxylate, dodecanol ethoxylate, isotridecyl alcohol ethoxylate, stearyl alcohol ethoxylate, linoleyl ethoxylate. In one embodiment the alkoxylate of a C₅-C₂₀ fatty alcohol is an ethoxylate of a stearyl alcohol. In another embodiment the alkoxylate of a C₅-C₂₀ fatty alcohol is a decanol ethoxylate. In a further embodiment the alkoxylate of a C₅-C₂₀ fatty alcohol is a tridecyl alcohol alkoxylate.

Preferred alkoxylates of C₅-C₂₀ fatty alcohols are alkoxylates of C₁₀-C₁₈ fatty alcohols, more preferably of C₁₂-C₁₈ fatty alcohols, and especially of C₁₂-C₁₅ fatty alcohols. The fatty alcohols may be branched or unbranched, saturated or unsaturated.

In a first embodiment the agrochemical composition comprises a copolymer (P) having a weight-average molecular weight of 50 000 to 500 000 g/mol (preferably of 100 000 to 500 000 g/mol) and a surfactant (preferably a nonionic surfactant), in particular an alkoxylate of fatty alcohols, as for example an ethoxylated C₅-C₂₀ fatty alcohol, in particular

In a second embodiment the agrochemical composition comprises a copolymer (P) having a weight-average molecular weight of at least 1 000 000 g/mol and no surfactant, preferably no nonionic surfactant.

In a third embodiment, the agrochemical composition comprises a copolymer (P) having a weight-average molecular weight of at least 1 000 000 g/mol and a nonionic surfactant, preferably polymerized alkylene oxide, examples being polyethylene oxide, polypropylene oxide, polybutylene oxide, mixed polymers of ethylene oxide and propylene oxide, or mixed polymers of ethylene oxide and butylene oxide, preferably polyethylene oxide or a mixed polymer of ethylene oxide and propylene oxide, more preferably a mixed polymer of ethylene oxide and propylene oxide, and in particular a block copolymer of ethylene oxide and propylene oxide.

In one version, the agrochemical compositions relates to concentrates which can be processed by dilution with water to form spray mixtures. In a second version the agrochemical composition relates to such spray mixtures.

The concentration of the copolymer (P) in spray mixtures is typically 10 to 1000 ppm, preferably 20 to 500 ppm, more preferably 30 to 100 ppm. The concentration of the copolymer (P) ranges typically up to 300 ppm, preferably up to 200 ppm, and especially up to 100 ppm. The concentration of the copolymer (P) is usually more than 40 ppm, preferably more than 45 ppm. In one embodiment the concentration of the copolymer (P) is at least 0.1 ppm, preferably at least 0.5 ppm, especially at least 1 ppm, as for example at least 5 ppm. In another embodiment the concentration of the copolymer (P) is 0.5 to 300 ppm, preferably 1 to 300 ppm, more preferably 1 to 250 ppm.

The dimensionless unit ppm as used in this application relates to the ratio of the mass of one substance divided by the mass of a second substance.

The concentration of the copolymer (P) in concentrates may attain 3 wt %, preferably 2.5 wt %, more preferably 0.8 wt %, and especially 0.5 wt %. The concentration of the copolymer (P) in concentrates is customarily up to 3 wt %, preferably up to 2 wt %, more preferably up to 1 wt %.

The concentration of the surfactant in the agrochemical composition, preferably of the nonionic surfactant, is usually in the range from 0.1 to 50 wt %, preferably from 0.5 to 40 wt % and more preferably from 1 to 30 wt %. The concentration in the agrochemical composition is up to 50 wt %, preferably up to 40 wt % and more preferably up to 30 wt %.

The agrochemical composition comprises a pesticide. The term “pesticide” identifies at least one active ingredient selected from the group of fungicides, insecticides, nematicides, herbicides, safeners, biopesticides and/or growth regulators. Preferred pesticides are fungicides, insecticides, herbicides, and growth regulators. Particularly preferred pesticides are growth regulators. Mixtures of pesticides from two or more of the aforementioned classes may also be used. The skilled person is familiar with such pesticides, which can be found for example in Pesticide Manual, 16th edn. (2013), The British Crop Protection Council, London. Suitable insecticides are insecticides from the class of the carbamates, organophosphates, organochlorine insecticides, phenylpyrazoles, pyrethroids, neonicotinoids, spinosyns, avermectins, milbemycins, juvenile hormone analogs, alkyl halides, organotin compounds, nereistoxin analogs, benzoylureas, diacylhydrazines, METI acaricides, and also insecticides such as chloropicrin, pymetrozine, flonicamid, clofentezine, hexythiazox, etoxazole, diafenthiuron, propargite, tetradifon, chlorfenapyr, DNOC, buprofezine, cyromazine, amitraz, hydramethylnon, acequinocyl, fluacrypyrim, rotenone, or derivatives thereof. Suitable fungicides are fungicides of the classes of dinitroanilines, allylamines, anilinopyrimidines, antibiotics, aromatic hydrocarbons, benzenesulfonamides, benzimidazoles, benzisothiazoles, benzophenones, benzothiadiazoles, benzotriazines, benzylcarbamates, carbamates, carboxamides, carboxylic acid amides, chloronitriles, cyanoacetamide oximes, cyanoimidazoles, cyclopropanecarboxamides, dicarboximides, dihydrodioxazines, dinitrophenylcrotonates, dithiocarbamates, dithiolanes, ethylphosphonates, ethylaminothiazole-carboxamides, guanidines, hydroxy-(2-amino)pyrimidines, hydroxyanilides, imidazoles, imidazolinones, inorganics, isobenzofuranones, methoxyacrylates, methoxycarbamates, morpholines, N-phenylcarbamate, oxazolidinediones, oximinoacetates, oximinoacetamides, peptidylpyrimidine nucleosides, phenylacetamides, phenylamides, phenylpyrroles, phenylureas, phosphonates, phosphorothiolates, phthalamic acids, phthalimides, piperazines, piperidines, propionamides, pyridazinones, pyridines, pyridinylmethylbenzamides, pyrimidinamines, pyrimidines, pyrimidinonehydrazones, pyrroloquinolinones, quinazolinones, quinolines, quinones, sulfamides, sulfamoyltriazoles, thiazolecarboxamides, thiocarbamates, thiophanates, thiophenecarboxamides, toluamides, triphenyltin compounds, triazines, triazoles. Suitable herbicides are herbicides from the classes of the acetamides, amides, aryloxyphenoxy-propionates, benzamides, benzofuran, benzoic acids, benzothiadiazinones, bipyridylium, carbamates, chloroacetamides, chlorcarboxylic acids, cyclohexanediones, dinitroanilines, dinitrophenol, diphenyl ethers, glycines, imidazolinones, isoxazoles, isoxazolidinones, nitriles, N-phenylphthalimides, oxadiazoles, oxazolidinediones, oxyacetamides, phenoxycarboxylic acids, phenylcarbamates, phenylpyrazoles, phenylpyrazolines, phenylpyridazines, phosphinic acids, phosphoroamidates, phosphorodithioates, phthalamates, pyrazoles, pyridazinones, pyridines, pyridinecarboxylic acids, pyridinecarboxamides, pyrimidinediones, pyrimidinyl(thio)-benzoates, quinolinecarboxylic acids, semicarbazones, sulfonylaminocarbonyltriazolinones, sulfonylureas, tetrazolinones, thiadiazoles, thiocarbamates, triazines, triazinones, triazoles, triazolinones, triazolocarboxamides, triazolopyrimidines, triketones, uracils, ureas.

Preferred pesticides are ionic pesticides, mostly selected from the class of the herbicides, examples being glyphosate, gluphosinate, paraquat, bipyridil, dicamba, 2,4-dichlorophenoxyacetic acid, aminopyralid, clopyralid, fluroxypyr, imazapyr, imazapic, 2-methyl-4-chlorophenoxyacetic acid, pendimethalin, or triclopyr. Preferred ionic pesticides are anionic pesticides, examples being glyphosate, gluphosinate, dicamba, 2,4-dichlorophenoxyacetic acid, aminopyralid, clopyralid, fluroxypyr, imazapic, 2-methyl-4-chlorophenoxyacetic acid, or triclopyr, more preferably glyphosate and dicamba. Another preferred herbicide is dimethenamid-P.

Further preferred pesticides are insecticides or fungicides. Examples are pyraclostrobin, metaflumizone, chlorthalonil, chlorfenapyr, broflanilide, 2-[4-(4-chlorophenoxy)-2-(trifluoro-methyl)phenyl]-1-(1,2,4-triazol-1-yl)propan-2-ol, 1-[4-(4-chlorophenoxy)-2-(trifluoromethyl)-phenyl]-1-cyclopropyl-2-(1,2,4-triazol-1-yl)ethanol, 2-[4-(4-chlorophenoxy)-2-(trifluoromethyl)-phenyl]-3-methyl-1-(1,2,4-triazol-1-yhbutan-2-ol, thiomethoxam, fipronil, epoxiconazole, trifloxystrobin, boscalid, azoxystrobin, alpha-cypermethrin, abamectin, cyflumetofen, cyclaniliprole, tetraniliprole, cyantraniliprole, chlorantraniliprole, imidacloprid, dinotefuran, chlothianidin, acetamiprid, thiacloprid, and spinosad.

In one embodiment the pesticide is selected from dimethenamid-P, 2-[4-(4-chlorophenoxy)-2-(trifluoromethyl)phenyl]-1-(1,2,4-triazol-1-yl)propan-2-ol, glyphosate, dicamba.

Mixtures of the aforesaid pesticide classes and/or of the specific pesticides are likewise possible.

The concentration of the pesticide in the agrochemical composition is typically from 5 to 99 wt %, preferably 10 to 99 wt %, more preferably 30-95 wt %.

The concentration of the pesticide in the agrochemical composition is at least 5 wt %, preferably at least 10 wt %, more preferably at least 20 wt %.

The agrochemical composition may be present in or converted into the customary kinds of agrochemical compositions, examples being solutions, emulsions, suspensions, dusts, powders, pastes, granules, compacts, capsules, and mixtures thereof. Examples of kinds of compositions are suspensions (e.g., SC, OD, FS), emulsifiable concentrates (e.g., EC), emulsions (e.g., EW, EO, ES, ME), capsules (e.g., CS, ZC), pastes, film-coated tablets, wettable powders or dusts (e.g., WP, SP, WS, DP, DS), compacts (e.g., BR, TB, DT), granules (e.g., WG, SG, GR, FG, GG, MG), insecticidal products (e.g., LN), and also gel formulations for the treatment of plant propagation material such as seeds (e.g., GF). These and further kinds of compositions are defined in “Catalogue of pesticide formulation types and international coding system”, Technical Monograph 2, 6th edition, May 2008, CropLife International. Preferred are suspensions, emulsifiable concentrates, emulsions, and solutions.

The compositions are produced in a known way, as for example in accordance with Mollet and Grubemann, Formulation technology, Wiley VCH, Weinheim, 2001; or Knowles, New developments in crop protection product formulation, Agrow Reports DS243, T&F Informa, London, 2005.

Suitable auxiliaries are solvents, liquid carriers, solid carriers or fillers, protective colloids, stickers, thickeners, humectants, repellents, attractants, feeding stimulants, compatibilizers, bactericides, frost preventatives, foam inhibitors, colorants, adhesives, and binders.

Suitable solvents and liquid carriers are water and organic solvents such as mineral oil fractions of moderate to high boiling point, e.g., kerosene, diesel oil; oils of vegetable or animal origin; aliphatic, cyclic and aromatic hydrocarbons, e.g., toluene, paraffin, tetrahydronaphthalene, alkylated naphthalenes; alcohols, e.g., ethanol, propanol, butanol, benzyl alcohol, cyclohexanol; glycols; DMSO; ketones, e.g., cyclohexanone; esters, e.g., lactates, carbonates, fatty acid esters, gamma-butyrolactone; fatty acids; phosphonates; amines; amides, e.g., N-methylpyrrolidone, fatty acid dimethylamides; and mixtures thereof.

Suitable solid carriers or fillers are mineral earths, e.g., silicates, silica gels, talc, kaolins, limestone, lime, chalk, clays, dolomite, diatomaceous earth, bentonite, calcium sulfate, magnesium sulfate, magnesium oxide; polysaccharides, e.g., cellulose, starch; fertilizers, e.g., ammonium sulfate, ammonium phosphate, ammonium nitrate, ureas; products of plant origin, e.g., cereal flour, bark flour, wood flour, nutshell flour, and mixtures thereof.

Suitable thickeners are polysaccharides (e.g., xanthan gum, carboxymethylcellulose), inorganic clays (organically modified or unmodified), polycarboxylates, and silicates.

Suitable bactericides are bronopol and isothiazoline derivatives such as alkylisothiazolinones and benzisothiazolinones.

Suitable frost preventatives are ethylene glycol, propylene glycol, urea, and glycerol.

Suitable foam inhibitors are silicones, long-chain alcohols, and salts of fatty acids.

Suitable colorants (e.g., in red, blue or green) are pigments, which are of poor solubility in water, and water-soluble dyes. Examples are inorganic colorants (e.g., iron oxide, titanium oxide, iron hexacyanoferrate) and organic colorants (e.g., alizarin, azo, and phthalocyanine colorants).

Suitable stickers or binders are polyvinylpyrrolidones, polyvinyl acetates, polyvinyl alcohols, polyacrylates, biological or synthetic waxes, and cellulose ethers.

Moist seed dressings (LS), suspoemulsions (SE), suspension concentrates (FS), seed powders (DS), slurry powders (WS), wet seed dressings (SS), emulsions (ES), emulsifiable concentrates (EC) and gels (GF) are commonly used for the treatment of plant propagation material, particularly of seeds. The compositions in question, following dilution by two to ten times, lead to active ingredient concentrations of 0.01 to 60 wt %, preferably of 0.1 to 40 wt %, in the ready-to-use preparations. Application may take place before or during sowing. The methods for the application of the compound I and compositions thereof to plant propagation material, especially seeds, or for treatment thereof with the compound I and compositions thereof, include dressing, coating, pelletizing, dusting, steeping of the propagation material, and application in the seed furrow. The compounds I and/or compositions thereof are preferably applied to the plant propagation material by a method which does not induce germination, as for example by seed dressing, pelletizing, coating and dusting.

For use in crop protection, the application rates of the active ingredients, depending on the nature of the desired effect, are 0.001 to 2 kg per ha, preferably 0.005 to 2 kg per ha, more preferably 0.05 to 0.9 kg per ha, and more particularly 0.1 to 0.75 kg per ha.

In the treatment of plant propagation material such as seeds, by dusting, coating or soaking of the seed, for example, the general requirement is for active ingredient quantities of 0.1 to 1000 g, preferably 1 to 1000 g, more preferably 1 to 100 g, and more particularly 5 to 100 g per 100 kg of plant propagation material (preferably seed).

For use in protection of materials or protection of goods in storage, the quantity of active ingredient used is dependent on the nature of the field of use and/or the desired effect. Quantities commonly used in the protection of materials are 0.001 g to 2 kg, preferably 0.005 g to 1 kg, of active ingredient per cubic meter of material treated.

The active ingredients or the compositions comprising them can be admixed, in the form of premixes or, optionally, not until shortly before use (tank mix), with various kinds of oils, wetting agents, adjuvants, fertilizers or micronutrients and also with further pesticides (e.g., herbicides, insecticides, fungicides, growth regulators, safeners). These agents may be admixed to the compositions of the invention in a weight ratio of 1:100 to 100:1, preferably 1:10 to 10:1.

The user typically applies the composition of the invention from a predosing device, a knapsack sprayer, a spray tank, a spray aircraft, or an irrigation system. The agrochemical composition is typically diluted with water, buffers and/or other auxiliaries to the desired delivery concentration, so as to give the ready-to-use spray fluid or agrochemical composition of the invention. 20 to 2000 liters, preferably 50 to 400 liters, of the ready-to-use spray mixture will typically be delivered per hectare of utilizable agricultural area.

According to one embodiment, it is possible for individual components of the composition of the invention, such as parts of a kit or parts of a two-component or three-component mixture, to be mixed by the user themselves in a spray tank, and, optionally, further auxiliaries may be added.

In a further embodiment, it is possible for either individual components of the composition of the invention or partly premixed components to be mixed by the user in a spray tank, and for further auxiliaries and adjuvants to be added, optionally.

In a further embodiment, either individual components of the composition of the invention or partly premixed components may be delivered jointly (e.g., after mixing in the tank) or sequentially.

The unit “ppm” as used in this description is dimensionless and relates to the weight concentration of a substance, such as of the copolymer (P), in a second substance, such as a solvent, for example.

### Advantages of the Invention

Features of the agrochemical composition include reduced formation of small droplets on spraying of the composition. As a result, wind drift is reduced, with beneficial consequences for safe handling, the consumption of pesticides, the toxicity, and the development of resistance. The copolymer (P) is nontoxic and can be produced on the industrial scale. The advantageous properties of the copolymer (P) are independent, furthermore, from the electrolyte content of the composition, and so there is a broad usefulness. Moreover, the copolymer (P) can be added to any formulation system, and the application rate of the copolymer (P) is lower by comparison with other additives for reducing spray drift.

The examples which follow are included for the purpose of illustrating the invention.

### EXAMPLES

Polymer A: 48 wt % 2-acrylamido-2-methylpropanesulfonate; 50 wt % acrylamide; 2 wt % hydroxybutyl vinyl ether alkoxylated with 20-30 ethylene oxide units, 10-20 butylene oxide units, and 1-10 ethylene oxide units; Mw>1 000 000 g/mol.

Polymer B: 45 wt % 2-acrylamido-2-methylpropanesulfonate; 50 wt % acrylamide; 5 wt % hydroxybutyl vinyl ether alkoxylated with 20-30 ethylene oxide units, 10-20 butylene oxide units, and 1-10 ethylene oxide units; Mw>1 000 000 g/mol.

Polymer C: 40 wt % 2-acrylamido-2-methylpropanesulfonate; 50 wt % acrylamide; 10 wt % hydroxybutyl vinyl ether alkoxylated with 20-30 ethylene oxide units, 10-20 butylene oxide units, and 1-10 ethylene oxide units; Mw>1 000 000 g/mol.

Comparative polymer D: 50 wt % 2-acrylamido-2-methylpropanesulfonate, 50 wt % acrylamide; Mw>1 000 000 g/mol.

Polymer E: 40 wt % 2-acrylamido-2-methylpropanesulfonate; 50 wt % acrylamide; 10 wt % hydroxybutyl vinyl ether alkoxylated with 20-30 ethylene oxide units, 10-20 butylene oxide units, and 1-10 ethylene oxide units; Mw 100 000-500 000 g/mol.

Comparative polymer F: 50 wt % 2-acrylamido-2-methylpropanesulfonate, 50 wt % acrylamide; Mw>100 000-500 000 g/mol.

Polymer H: 48 wt % 2-acrylamido-2-methylpropanesulfonate; 45 wt % acrylamide; 5 wt % N-vinylpyrrolindone; 2 wt % hydroxybutyl vinyl ether alkoxylated with 20-30 ethylene oxide units, 10-20 butylene oxide units, and 1-10 ethylene oxide units; Mw>1 000 000 g/mol.

Surfactant A: nonionic C₁₀-C₁₅ alcohol ethoxylate, dynamic viscosity 75 mPas, miscible with water in any proportion.

Surfactant B: nonionic alkoxylate, containing polyethylene oxide and polypropylene oxide as block copolymer, M_{w} 800 to 1100 g/mol.

Surfactant C: ethoxylated tallowamine; degree of ethoxylation 15-25 EO units per molecule.

Surfactant D: nonionic condensation product containing polyethylene oxide and polypropylene oxide as block copolymer; molar weight about 6500 g/mol; 50 wt % fraction of polymerized ethylene oxide.

Surfactant E: mixture of polyamine phosphate, naphtha, and polyoxyethylene fatty ammonium methosulfate, liquid at 25° C.

Solvent A: hydrocarbon mixture containing at least 99 wt % of aromatic hydrocarbons; naphthalene concentration less than 0.9 wt %.

Wetting agent A: benzenesulfonic acid-formaldehyde-phenol-urea condensate; sodium salt. Hyperbranched polymer: polymer of polytetrahydrofuran and citric monohydrate, modified with isophorone diisocyanate, methylpolyethylene glycol, and C₁₆-C₁₈ fatty alcohol polyethylene glycol, as disclosed in synthesis example 8 in PCT/EP2015/079344.

Filler A: magnesium aluminum silicate; smectite.

Thickener A: xanthan.

Biocide: mixture of 2.5 wt % 1,2-benzisothiazolin-3-one and 2.5 wt % 2-methyl-4-isothiazolin-3-one.

Defoamer: nonionic silicone oil, pH 5-8.

Fungicide A: 2-[4-(4-chlorophenoxy)-2-(trifluoromethyl)phenyl]-1-(1,2,4-triazol-1-yl)propan-2-ol.

Herbicide A: dimethenamid-P.

Preparation of the polymers: the inventive and comparative polymers A to D and H in the experiments were prepared by gel polymerization as described above, in analogy to the published preparation process in examples 2 to 8 in WO 2010/133527.

The inventive and comparative polymers E and F were prepared by solution polymerization as described above.

Preparation of the monomers: the alkoxylated hydroxybutyl vinyl ethers used in the inventive and comparative polymers in the experiments were prepared by the preparation protocol described in the experimental section for preparing the macromonomers (B) in PCT/EP2014/076772.

### Example-1: Reduction of the Fraction of Fine Droplets by High Molecular Mass Polymers

Four different aqueous solutions S1, S2, S3 and S4 each containing only one of the polymers A, B, C or comparative polymer D in that order were produced with a concentration of 50 ppm. The solutions were sprayed through an XR nozzle (XR-11004, Teejet) at a pressure of 2.78 bar. The fraction of fine droplets having a diameter of less than 100 μm was measured by laser scattering, with detection by means of a CCD detector. The results have been set out in table 1.

TABLE 1

| | Water | S1 | S2 | S3 | S4* |
|---|---|---|---|---|---|
| Fraction of fine | 16.5 | 12.5 | 11.8 | 11 | 14.5 |
| droplets in % | | | | | |

*comparative experiment

### Example-2: Reduction of the Fraction of Fine Droplets by Low Molecular Mass Polymers

Two different aqueous solutions S5 and S6 each containing only one of the polymers E or comparative polymer F in that order were prepared with a concentration of 50 ppm. The reduction in the fraction of fine droplets during spraying was carried out as in example 1. The results have been set out in table 2.

TABLE 2

| | Water | S5 | S6* |
|---|---|---|---|
| Fraction of fine | 16.5 | 14 | 16 |
| droplets in % | | | |

*comparative experiment

### Example-3: Variation in the Alkoxylation Pattern of Copolymer (P)

Polymers G1 to G9 were prepared by gel polymerization. All contained 48 wt % of 2-acrylamido-2-methylpropanesulfonate, 50 wt % of acrylamide and 2 wt % of hydroxybutyl vinyl ether and had a weight-average molecular weight of 100 000 to 500 000 g/mol. The alkoxylation of the hydroxybutyl vinyl ether was altered in accordance with table 3, with the indices a, b and d corresponding to those in formula I and indicating the number of the ethylene oxide, butylene oxide and ethylene oxide units in that order.

The polymers were dissolved in water at a concentration of 50 ppm, and the droplet size during spraying was measured as in example-1. The results are set out in table 4, with all of the measurements having been standardized to water.

TABLE 3

| Polymer | Index a | Index b | Index d |
|---|---|---|---|
| G1 | 24.5 | 16 | 0 |
| G2 | 24.5 | 5 | 3.5 |
| G3 | 24.5 | 16 | 10 |
| G4 | 24.5 | 10 | 3.5 |
| G5 | 24.5 | 16 | 3.5 |
| G6 | 24.5 | 16 | 16 |
| G7 | 12 | 16 | 16 |
| G8 | 125 | 16 | 3.5 |
| G9 | 24.5 | 22 | 3.5 |

TABLE 4
Investigation of solutions of polymers G1 to G9

| | Water | G1 | G2 | G3 | G4 | G5 |
|---|---|---|---|---|---|---|
| Standardized | 100 | 68 | 70 | 71 | 65 | 72 |
| fraction | | | | | | |
| of fine | | | | | | |
| droplets in % | | | | | | |

| | G6 | G7 | G8 | G9 |
|---|---|---|---|---|
| Standardized | 69 | 70 | 58 | 62 |
| fraction | | | | |
| of fine | | | | |
| droplets in % | | | | |

### Example-4: Concentration Dependence of the Reduction in the Fraction of Fine Droplets

Aqueous solutions S7 to S9 of polymer A with concentrations corresponding to table 5 were prepared.

TABLE 5

| | S7 | S8 | S9 |
|---|---|---|---|
| Concentration of | 50 | 70 | 90 |
| polymer A in ppm | | | |

The reduction in the fraction of fine droplets during spraying was carried out as in example 1. The results have been set out in table 6.

TABLE 6

| | Water | S7 | S8 | S9 |
|---|---|---|---|---|
| Fraction of fine | 15.3 | 14 | 12 | 10 |
| droplets in % | | | | |

### Example-5: Cooperative Effect of Copolymer (P) and Nonionic Surfactants

An aqueous solution S10 of polymer E at a concentration of 50 ppm was admixed with different concentrations of surfactant A, and the reduction in the fraction of fine droplets during spraying was carried out as in example 1. The results have been set out in table 7.

TABLE 7

Concentration of surfactant A in wt %

| | 0 | 1 | 2.5 | 5 | 10 |
|---|---|---|---|---|---|
| Fraction of fine | 14.8 | 9.5 | 9 | 10 | 11.5 |
| droplets in % | | | | | |

### Example-6: Cooperative Effect of Copolymer (P) and Nonionic Surfactants

An aqueous solution S11 of polymer A at a concentration of 50 ppm, containing 2000 ppm of surfactant B, was prepared and the reduction in the fraction of fine droplets during spraying was carried out as in example 1. The results have been set out in table 8.

TABLE 8

| | Water | S11 |
|---|---|---|
| Fraction of fine | 17 | 14 |
| droplets in % | | |

### Example-7: Reduction in the Fraction of Fine Droplets in SL Formulations

The aqueous solution formations SL-1 and SL-2 containing glyphosate, dicamba-BAPMA, surfactant C and polymer B or polymer C, and also the comparative formulation SL-1* without polymer, were prepared in accordance with the concentrations in table 9.

TABLE 9

| Ingredient | SL-1 | SL-2 | SL-1* |
|---|---|---|---|
| Glyphosate in g/l | 11.2 | 11.2 | 11.2 |
| Dicamba-BAPMA | 5.6 | 5.6 | 5.6 |
| in g/l | | | |
| Polymer A in ppm | 50 | — | — |
| Polymer B in ppm | — | 50 | — |
| Surfactant C in g/l | 3 | 3 | 3 |

The reduction in the fraction of fine droplets during spraying was carried out as in example 1. The results have been set out in table 10.

TABLE 10

| | SL-1 | SL-2 | SL-1* |
|---|---|---|---|
| Fraction of fine | 3 | 4 | 9 |
| droplets in % | | | |

### Example-8: Concentration Dependence of the Reduction in the Fraction of Fine Droplets in SL Formulations

The aqueous solution formulations SL-3, SL-4 and SL-5, containing glyphosate, dicamba-BAPMA and polymer A, and also the comparative formulation SL-2*without polymer, were prepared in accordance with the concentrations in table 11.

TABLE 11

| Ingredient | SL-3 | SL-4 | SL-5 | SL-2* |
|---|---|---|---|---|
| Glyphosate in g/l | 11.2 | 11.2 | 11.2 | 11.2 |
| Dicamba-BAPMA in g/l | 5.6 | 5.6 | 5.6 | 5.6 |
| Polymer A in ppm | 50 | 70 | 90 | — |

The reduction in the fraction of fine droplets during spraying was carried out as in example 1. The results have been set out in table 10.

TABLE 12

| | SL-3 | SL-4 | SL-5 | SL-2* |
|---|---|---|---|---|
| Fraction of fine | 6 | 3.8 | 2.1 | 8.3 |
| droplets in % | | | | |

### Example-9: Concentration Dependence of the Reduction in the Fraction of Fine Droplets in Pesticide Suspensions

The aqueous suspensions SP-1 to SP-7, and also the comparative suspension concentrate SP-1* without the polymer of the invention, were produced with the ingredients corresponding to table 13. For this purpose, water, fungicide A, surfactant D, hyperbranched polymer and defoamer were mixed. The mixture was ground with a ball mill to a particle size of 2 μm. Propylene glycol, biocide and thickener A were added. Mixing gave homogeneous suspensions. These suspensions were admixed with water and polymer A to give the suspensions SP-1 to SP-7 and SP-1*. Table 13 showed the final concentrations of the ingredients.

TABLE 13

| Ingredient | SP-1 | SP-2 | SP-3 | SP-4 | SP-5 | SP-6 | SP-7 | SP-1* |
|---|---|---|---|---|---|---|---|---|
| Fungicide A | 0.375 | 0.375 | 0.375 | 0.375 | 0.375 | 0.375 | 0.375 | 0.375 |
| in g/l | | | | | | | | |
| Polymer A | 35 | 17.5 | 8.75 | 4.5 | 2.2 | 1.1 | 0.5 | — |
| in ppm | | | | | | | | |
| Propylene | 0.1 | 0.1 | 0.1 | 0.1 | 0.1 | 0.1 | 0.1 | 0.1 |
| glycol in g/l | | | | | | | | |
| Surfactant D | 45 | 45 | 45 | 45 | 45 | 45 | 45 | 45 |
| in ppm | | | | | | | | |
| Hyperbranched | 1 | 1 | 1 | 1 | 1 | 1 | 1 | 1 |
| polymer in g/l | | | | | | | | |
| Filler A | 75 | 75 | 75 | 75 | 75 | 75 | 75 | 75 |
| in ppm | | | | | | | | |
| Thickener A | 10 | 10 | 10 | 10 | 10 | 10 | 10 | 10 |
| in ppm | | | | | | | | |
| Biocide in | 2 | 2 | 2 | 2 | 2 | 2 | 2 | 2 |
| g/l | | | | | | | | |
| Defoamer in | 25 | 25 | 25 | 25 | 25 | 25 | 25 | 25 |
| ppm | | | | | | | | |
| Water | to | to | to | to | to | to | to | to |
| | 1 liter | 1 liter | 1 liter | 1 liter | 1 liter | 1 liter | 1 liter | 1 liter |

*comparative experiment

The reduction in the fraction of fine droplets during spraying was carried out as in example 1, but a pressure of 4 bar was applied when spraying. The results have been set out in table 14.

TABLE 15

| | SP-1 | SP-2 | SP-3 | SP-4 | SP-5 | SP-6 |
|---|---|---|---|---|---|---|
| Fraction of | 1.32 | 1.32 | 1.67 | 2.60 | 2.68 | 3.02 |
| fine droplets | | | | | | |
| in % | | | | | | |

| | SP-7 | SP-1* |
|---|---|---|
| Fraction of | 3.13 | 3.33 |
| fine droplets | | |
| in % | | |

*comparative experiment

### Example-10: Concentration Dependence of the Reduction in the Fraction of Fine Droplets in Emulsions

The aqueous emulsifiable concentrate EC-1 was prepared with the ingredients corresponding to table 16.

TABLE 16

| Ingredient | Herbicide A | Surfactant E | Solvent A |
|---|---|---|---|
| Concentration in g/l | 720 | 113 | to 1 liter |

Thereafter, EC-1 was diluted with 30 liters of water and polymer A was added up to a concentration of 233 ppm. The resulting spray mixture SB-8 was sprayed under a pressure of 4 bar through an ID nozzle (air injection nozzle ID). The fraction of fine droplets was otherwise determined as described in example 1. The results have been set out in table 17 in comparison with water.

TABLE 17

| | SB-8 | Water |
|---|---|---|
| Fraction of fine droplets in % | 1.48 | 4.3 |

### Example-11: Reduction in the Fraction of Fine Droplets in the Presence of Further Monomers

An aqueous solution S12 of polymer H with a concentration of 50 ppm was prepared, and the reduction in the fraction of the fine droplets during spraying was carried out as in example 1 in comparison with water, or in comparison with the aqueous solution S1 from example 1. The results have been set out in table 18.

TABLE 18

| | S1 | S12 | Water |
|---|---|---|---|
| Standardized fraction of fine | 77 | 69 | 100 |
| droplets in % | | | |

1. An agrochemical composition comprising a pesticide and at least one water-soluble copolymer (P), wherein the copolymer (P) at least comprises:
30 to 99.99 wt % of at least one monomer (A), selected from the group consisting of: (meth)acrylamide, N-methyl(meth)acrylamide, N,N′-dimethyl(meth)acrylamide and N-methylol(meth)acrylamide;
0.01 to 15 wt % of at least one macromonomer (B), macromonomer (B) at least comprising a macromonomer (B1) comprising H₂C═C(R¹)—R²—O—(R³O)ₐ—(R⁴O)_{b}—H; and
0.1 to 69.99 wt % of at least one anionic monoethylenically unsaturated monomer (C), comprising at least one acidic group selected from the group consisting of: —COOH, —SO₃H, PO₃H₂, and salts thereof;
wherein:
R¹ comprises one of H and methyl,
R² comprises one of a single bond and a divalent linking group —OR³⁵, wherein R³⁵ is an alkylene group having 1 to 6 carbon atoms,
R³ comprises, independently at each occurrence, one of ethylene groups —CH₂CH₂—, 1,2-propylene groups —CH₂—CH(CH₃)—, and alkylene groups R⁴, wherein at least 90 mol % of the radicals R³ are ethylene groups,
R⁴ comprises, independently at each occurrence, alkylene groups —CR⁶(R⁷)—CR⁸(R⁹)—, wherein the radicals R⁶, R⁷, R⁸ and R⁹ independently of one another are one of H, a linear branched alkyl radical having 1 to 8 carbon atoms, and a branched alkyl radical having 1 to 8 carbon atoms, wherein not all the radicals are H and the sum of the carbon atoms in the radicals R⁶, R⁷, R⁸ and R⁹ is 2 to 8,
R⁵ comprises an ethylene group —CH₂CH₂—,
a is a number from 10 to 150,
b is a number from 5 to 30,
c is a number from 0 to 2,
d is a number from 0 to 20, and
wherein the respective amounts of the monomers are based in each case on a total amount of all the monomers in the copolymer (P).

2. The agrochemical composition according to claim 1, wherein d is a number from 1 to 15.

3. The agrochemical composition according to claim 2, wherein the copolymer (P) comprises at least one additional macromonomer (B2) comprising
H₂C═C(R¹)—R²—O—(R³O)ₐ—(R⁴O)_{b}—H,
wherein a molar fraction x of the macromonomers (B1) relative to a sum of (B1) and (B2) is 0.1 to 0.99.

4. The agrochemical composition according to claim 1, wherein R¹ is H, R² is OR³⁵, and R³ is —CH₂CH₂—.

5. The agrochemical composition according to claim 1, wherein a is a number from 20 to 28, b is a number from 8 to 20, and d is a number from 2 to 5.

6. The agrochemical composition according to claim 1, wherein one of 2 and 3 of R⁶, R⁷, R⁸ and R⁹ are H, and a sum of the carbon atoms in R⁶, R⁷, R⁸ and R⁹ is one of 2 and 3.

7. The agrochemical composition according to claim 1, wherein a sum of b and c in R⁴O is selected such that a sum of all the carbon atoms of all of R⁶, R⁷, R⁸ and R⁹ present is 25 to 50.

8. The agrochemical composition according to claim 1, wherein the copolymer (P) comprises at least two different monomers (C).

9. The agrochemical composition according to claim 1, wherein the copolymer (P) comprises at least one monomer (C) of the formula (I)
CH₂═CH₂—C(O)XR¹⁰SO₃H (I),
wherein:
X is one of N and O; and
R¹⁰ comprises one of —CH₂—, —CH₂CH₂—, —C(CH₃)₂—, —CHCH₃—, —CH(CH₃)CH₂—, —CH₂CH(CH₃)—, and —C(CH₃)₂CH₂—, —CH₂C(CH₃)₂—.

10. The agrochemical composition according to any claim 1, wherein the copolymer (P) comprises at least one monomer (C) having a —COOH group.

11. The agrochemical composition according to claim 1, wherein the copolymer (P) has a weight-average molecular weight of at least 1,000,000 g/mol.

12. The agrochemical composition according to claim 1, wherein the copolymer (P) has a weight-average molecular weight of 100,000 to 600,000 g/mol.

13. The agrochemical composition according to claim 1, further comprising at least one nonionic surfactant.

14. The agrochemical composition according to claim 13, wherein the nonionic surfactant is one of an alcohol alkoxylate and a polyalkylene oxide.

15. A method for producing a spray mixture, the method comprising combining a pesticide, a water-soluble copolymer (P), as defined in claim 1, and water.

16. A method for controlling at least one of phytopathogenic fungi, unwanted plant growth, unwanted insect infestation, and mite infestation and for regulating plant growth, the method comprising applying the agrochemical composition defined in claim 1 on at least one of a pest, its environment, a crop plant to be protected from the pest, on soil, an unwanted plant, and an environment of the unwanted plant.

17. The agrochemical composition according to claim 10, wherein the —COOH group is (meth)acrylic acid.
